(19) United States
(12) Patent Application Publication
(10) Pub. No.: US 2025/0097123 A1
(43) Pub. Date: Mar. 20, 2025

(54) SYSTEM AND METHOD FOR LONG-TERM COMPILATION AND RETRIEVAL OF PAST DATA IN NETWORK PERFORMANCE ANALYSIS

(71) Applicant: RAKUTEN SYMPHONY, INC., Tokyo (JP)

(72) Inventors: Kishor MUKATI, Indore (IN); Vijay PATEL, Indore (IN); Rajat GORAKHPURIYA, Indore (IN); Samyak JAIN, Indore (IN)

(73) Assignee: RAKUTEN SYMPHONY, INC., Tokyo (JP)

(21) Appl. No.: 18/017,806

(22) PCT Filed: Nov. 15, 2022
(86) PCT No.: PCT/US2022/049904

§ 371 Date: Jan. 24, 2023

(51) Int. Cl. H04L 43/04; H04L 41/02; H04L 41/14

(52) U.S. Cl. CPC H04L 43/04; H04L 41/024; H04L 41/14

(57) ABSTRACT

To store network performance data for later retrieval, performance data files corresponding to a testing cycle are obtained, reformatted according to a predetermined uniform file format and a predefined set of uniform category identifiers into uniform data files, and stored to a query database. The reformatting may match predefined uniform category identifiers to data category identifiers in the performance data files, and the corresponding data values may be stored in a sequence in the uniform data files or used to increase a counter value in an aggregate counter file which is also stored. Additionally, configuration data files for network cells may be stored at a lesser frequency than that of the testing cycles. Later retrieval may retrieve both uniform data files and configuration data files corresponding to a selected time frame and network portion, and merge or aggregate the data suitably, for performance indicator computation.

### BACKGROUND

### 1. Field

Apparatuses and methods consistent with example embodiments relate to network performance analysis, and more particularly, to efficient long-term storage, compilation, and retrieval of data for analysis of network performance in the past and/or over time.

### 2. Description of Related Art

For large networks such as mobile networks, physically inspecting every component is not practical. Problematic components are instead identified by the effects they have on network behavior. Computing devices connected to the network, including both base unit systems and mobile devices, can monitor the network behavior and generate data logs. These logs can be then analyzed to determine where the network is not performing as intended.

Intended levels of performance are typically defined according to various quantifiable metrics, which are termed “key performance indicators” or “KPIs” in the field. When the measured or computed value for a KPI is not achieving the intended level, further investigation to determine the source of the problem is warranted. KPIs are additionally useful to evaluate improvements in performance resulting from system upgrades, and to generally monitor and predict development of the network.

### SUMMARY

It is an object of the disclosed system and method to store network performance data in a manner that can be easily retrieved based on a selected past time frame.

It is another object of the disclosed system and method to reduce redundant data in the stored network performance data.

It is yet another object of the disclosed system and method to automatically convert data from multiple disparate sources into uniform data files for searching.

In accordance with certain embodiments of the present disclosure, a method is provided for long-term storage of network performance data for later retrieval. The method includes obtaining a plurality of performance data files corresponding to the testing cycle. Each of the plurality of performance data files includes data describing network performance. The plurality of performance data files include at least a first data file of a first format and a second data file of a second format different from the first format. The method further includes reformatting each of the plurality of performance data files according to a predetermined uniform file format and a predefined set of uniform category identifiers, to obtain a plurality of uniform data files. The method further includes storing the plurality of uniform data files to a query database in a memory.

In accordance with other embodiments of the present disclosure, a method is provided for analysis of past network performance. The method includes storing a plurality of uniform data files to a query database in a memory. The method further includes searching the query database according to a received search request to thereby obtain a retrieved set of uniform data files. The method further includes computing at least one performance indicator based on the retrieved set of uniform data files.

In accordance with still other embodiments of the present disclosure, a system is provided for long-term storage of network performance data for later retrieval. The system includes at least one non-volatile memory electrically configured to store computer program code. The system further includes at least one processor operatively connected to the non-volatile memory, which is configured to operate as instructed by the computer program code. The computer program code includes file retrieval code configured to cause at least one of the at least one processor to obtain a plurality of performance data files corresponding to a testing cycle. Each of the plurality of performance data files includes data describing network performance. The plurality of performance data files include at least a first data file of a first format and a second data file of a second format different from the first format. The computer program code further includes formatting code configured to cause at least one of the at least one processor to reformat each of the plurality of performance data files according to a predetermined uniform file format and a predefined set of uniform category identifiers, to obtain a plurality of uniform data files. The computer program code further includes storage code configured to cause at least one of the at least one processor to store the plurality of uniform data files to a query database in a query memory.

In accordance with yet other embodiments of the present disclosure, a non-transitory computer-readable recording medium having recorded thereon instructions executable by at least one processor to perform a method for long-term storage of network performance data for later retrieval. The method includes obtaining a plurality of performance data files corresponding to the testing cycle. Each of the plurality of performance data files includes data describing network performance. The plurality of performance data files include at least a first data file of a first format and a second data file of a second format different from the first format. The method further includes reformatting each of the plurality of performance data files according to a predetermined uniform file format and a predefined set of uniform category identifiers, to obtain a plurality of uniform data files. The method further includes storing the plurality of uniform data files to a query database in a memory.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1A is a flow diagram illustrating a flow of processes for efficient storage of data for past KPI computation, in accordance with an exemplary embodiment;

FIG. 1B is a flow diagram illustrating a flow of processes for rapid past KPI computation, in accordance with an exemplary embodiment;

FIG. 2 is a flow diagram illustrating a flow of processes for reformatting of raw data files, in accordance with an exemplary embodiment;

FIG. 3 is a flow diagram illustrating a flow of processes for validating a reformatted data file, in accordance with an exemplary embodiment;

FIG. 4A is a block diagram illustrating a system for processing a data search query, in accordance with an exemplary embodiment;

FIG. 4B is a flow diagram illustrating a flow of processes for processing a data search query, in accordance with an exemplary embodiment;

FIG. 5 is a flow diagram illustrating a flow of processes for computing a KPI, in accordance with an exemplary embodiment; and

FIG. 6 is a diagram of example components of a device on which embodiments of the systems and/or methods described herein may be implemented.

### DETAILED DESCRIPTION

The following detailed description of example embodiments refers to the accompanying drawings. The same reference numbers in different drawings may identify the same or similar elements. The embodiments are described below in order to explain the disclosed system and method with reference to the figures illustratively shown in the drawings for certain exemplary embodiments for sample applications.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

It is noted that the principles disclosed herein are generally applicable to all forms of networks, including but not limited to internet service provider networks such as optical fiber and cable networks; traditional phone networks; both wired and wireless networks in a structure, complex, or other localized area; and even non-communication networks such as power grids. However, throughout the disclosure, the network being analyzed and managed by the disclosed system will be primarily referred to as a mobile network for purposes of convenience and brevity.

As briefly discussed in the Background, regular review of key performance indicators (KPIs) in a network are an advisable part of quality assurance testing for large networks. These reviews determine if the values of the KPIs are meeting baseline or goal thresholds, either generally or after an upgrade, and also monitor trends in these values over time to determine where development might be necessary in the future.

A KPI may be computed for an entire network or for any portion thereof. Portions of the network can be defined as one or more cells, which themselves are each defined by the particular cellular tower or other transceiver through which devices considered “in” the cell are coupled. Cells do not have defined physical boundaries, such that a device crossing such a physical boundary consistently disconnects from the transceiver of the cell and connects to a transceiver of a neighboring cell. However, when selecting a portion of a network according to an area of a map of a physical region, the cells that are “within” the selected portion can be defined according to the transceivers which are physically within the corresponding selected area. Since portion selection of this style is typically done by “drawing” a polygonal shape onto a digital map representation, a resulting selected network portion is sometimes referred to as the selected “polygon.” Polygons may also be defined on diagrams which visually represent the network according to something other than physical area, such as a chart of transceiver interconnections or a hierarchical chart. Furthermore, network portions may also be defined and selected according to other criteria, such as all cells managed by or through a particular central network unit or hub, all cells operating on a particular technology standard (e.g. 4G, 5G) or operating system, and so forth; testing a portion defined according to each of these criteria may be equivalent to testing the feature common to that portion.

As briefly discussed in the background, the data used to measure or compute a value for a KPI (for brevity, described herein as “computing the KPI”) may be gathered regularly by various computing systems connected to the network. The data may more specifically be values of various parameters: for example, identifier values, including but not limited to the model of a device and the communication protocols it uses; measured values, including but not limited to ping time and bandwidth; and counter values (sometimes simply termed “counters”), including but not limited to a number of dropped connections or particular functions calls in a specified period of time.

The data logs for a mobile network can be enormous, and keeping them in a local memory of an analytical system for an extended period, especially as new data continues to arrive, is not practical. Additionally, the most recent data is typically the most relevant to KPI computation. Therefore, as new data (which may be termed “current data”) is retrieved and requires room for storage, the older data (which may be termed “historical data” or “past data”) may be moved to a mid-term or long-term storage memory in a database, such as an EdgeDB® database, or in another searchable format, to be retrieved only if necessary. Many data analytics tools which are suitable as a basis for KPI computation, such as Apache® Spark, include functionality to store and retrieve data in this manner.

This approach, however, complicates computations of KPIs regarding behaviors of the network in the past.

As an illustrative example, it may be desirable to conduct a postmortem analysis regarding an event on the network three days prior. A search may be conducted on the long-term storage memory to retrieve historical data from that timeframe—that is, from the testing cycle or cycles occurring at the time of the event, as well as those immediately surrounding the event if relevant—so that KPIs can be computed for the event, particularly KPIs that are not computed as part of a standard testing cycle (and therefore were not computed at the time of the event) but are relevant in this case due to the nature of the event. However, the amount of historical data for any one testing cycle can be sizable. Additionally, due to the amount of historical data in the database as a whole, a search for even one data element within can be unduly intensive. Using conventional database searches, such as those provided by Spark SQL, it can take an unreasonable amount of time to retrieve all the historical data relevant to an event three days ago from the database; it may be hours before everything necessary to compute the applicable KPIs is collected. When a KPI is to be computed for a particular network portion, the search is more lengthy, despite the retrieval of less data, as the search must consider the data in the database according to additional parameters beyond a timestamp or testing cycle label to determine what data to retrieve.

This problem is amplified when retrieving historical data from multiple testing cycles. As an illustrative example, it may be desirable to introduce a new KPI to the standard analysis. Ideally, a baseline threshold for that KPI, which represents a value for the KPI that indicates the network is operating without issue, would be established at the same time. A goal may also be developed and is frequently based on the baseline. However, developing such a baseline, in many instances, requires the computing of a plurality of historical values for that KPI, each from a different testing cycle. Each such historical value requires its own set of retrievals of relevant historical data for a selected testing cycle before computation can occur. Due to the magnitude of such a retrieval process, in terms of processing time and resources, as a practical matter one might instead start without a baseline and develop one after several cycles of standard testing of the KPI, or develop an initial baseline on the basis of only one or two historical testing cycles and adjust later. Such is not ideal, as it is better to have an accurate baseline as early as possible, but these are the only practical solutions using conventional systems.

Briefly, example embodiments of the present disclosure provide a method and system in which, either as an alternative to or in addition to a long term storage database solution, historical data can be gathered from other sources. Embodiments of the disclosed method and system more particularly exploit and improve performance monitoring tools to compile and retrieve, in the long term, an abbreviated version of historical data logs, which may be formatted more efficiently for reading of particular parameters at the expense of completeness, size efficiency, or other factors which are less important when prompt access is needed.

In more specific embodiments, an improved performance monitoring tool may be configured to copy elements of recently gathered logs from the short-term data storage, and store these elements in a more efficient format which is easier to query and retrieve.

Additionally, an improved site configuration tool may be configured to store a history of configuration data for each transceiver and its corresponding cell, including but not limited to cell name, location, beam azimuth and tilt, frequency, bandwidth, operating system, and technology standard (e.g. 4G, 5G). Though values for this data potentially change over time, they are not expected to change with each testing cycle, and therefore the site configuration tool can store a history of this data in terms of periods under which any particular value remains steady, which is more efficient than storing a different datapoint for each testing cycle. For example, the site configuration tool may store data logs only once a day, in contrast to a testing cycle of every fifteen minutes. As such, data already stored by the site configuration tool may be omitted from the performance monitoring tool data, reducing storage use by the latter and easing retrieval thereof. The relevant portions of the site configuration tool data may then be compiled together with the performance monitoring tool data, each according to the specific time frame being queried, at the time of query. The site configuration tool data is not necessarily used in the KPI computations themselves, but may be used to correlate the performance monitoring tool data to particular cells and their corresponding configuration features, which in turn allows a computation to be according to a particular polygon or other defined portion of the network.

Using the data stored by these tools, in accordance with processes disclosed within and variations thereof, KPI computation for older time frames becomes feasible within a reasonable period of time.

Hereinafter, a KPI computed using past data rather than, or in addition to, current data will be termed a “past KPI.”

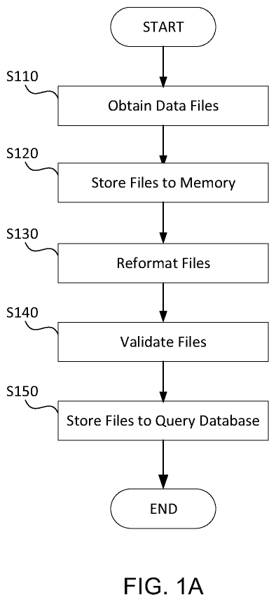

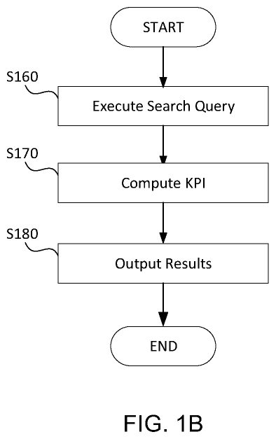

FIG. 1A is a flow diagram illustrating a flow of processes for efficient storage of data for past KPI computation, in accordance with an exemplary embodiment.

At S110, an element management system server (EMS server) obtains raw data files corresponding to a current testing cycle. The raw data files may be stored on the EMS server for a short period, making them available for current KPI determinations, before being moved to a mid-term storage database on another memory to clear storage space in its memory for newer data. The current KPI determinations, which will not be detailed herein, may be performed by a processor of the EMS server or by another system.

A suitable period of storage for both this purpose and for the abbreviated storage process to be described is twelve hours, but this is only an example. Ideal periods of short term storage on the EMS server may depend on the speed and storage capacity of the processors and memories used, and the rate of incoming raw data, among other factors.

At S120, each raw file is stored in a database on a memory. This memory may be organized according to any suitable standard for unstructured data, including but not limited to MinIO® and Hadoop® Distributed File System. An unstructured data storage may be necessary as the raw files do not yet necessarily share a uniform file format, but may each be formatted according to the standards and preferences of respective device vendors. If the EMS server is sufficiently efficient, it may store the raw files in its own memory and perform the operations to follow on its own processor, but a separate system for this storage is also within the scope of the disclosure.

The data in each raw file is reformatted according to a uniform file format and a set of uniform category identifiers at S130, in a manner that will be described further herein. The resulting files are then validated at S140 to confirm that the formatting was successful, also in a manner that will be described further herein. Finally, the validated files are stored to a query database, implemented on a query memory, at S150. The query database may be the same database as used at S120, or a different database on the same memory, or a different database on a different memory.

If a different database than the query database is used at S120, then the database used at S120 may be termed a temporary database. Likewise, if a different memory than the query memory is used at S120, then the memory used at S120 may be termed a temporary memory.

If the raw files stored at S120 are already in the desired common file format, operation S130 may still occur, either to generate a new file or to amend the existing file to contain only data for certain predetermined data categories.

FIG. 1B is a flow diagram illustrating a flow of processes for rapid past KPI computation, in accordance with an exemplary embodiment.

At S160, the query database is searched for data according to a received request, to identify data which (a) falls within the defined search parameters and (b) is relevant to the selected KPI to be computed. A search query may be applied to the data files by a suitable query engine. An effective architecture and process for queries applied to this form of data will be each described further herein.

At S170, a past KPI is computed using the data retrieved according to the query, and at S180, the results are outputted. The process then ends.

As previously noted, the raw files retrieved at S110 may be in differing file formats. Formats which are suitable for this form of data include Extensible Markup Language (XML) and XML-like formats (which are collectively termed “parsed structure files” herein), as well as comma-separated value (CSV) files and Optimized Row Columnar (ORC) files, among others.

A single uniform format for the files prior to KPI computation is generally preferred. Reformatting of the raw data files into uniform files may therefore be a part of the storage process. The reformatting may, in addition, filter out unnecessary categories of data to leave only the data desired for past KPI computations. The desired categories of data may be defined according to a predefined set of uniform category identifiers, which may be used to define a framework for the content of the uniform file.

Testing has determined the ORC format to be particularly effective for many of the computation operations described herein, in terms of both read time during queries and storage size in the query database. In particular, ORC format enables rapid location and retrieval of particular “stripes” of data from within each data file, rather than the entire file, for when a query seeks data from particular categories. However, “counter data” is determined to be more efficiently stored in a parsed structure file. Therefore, certain embodiments of the disclosure may use a hybrid approach to the data format.

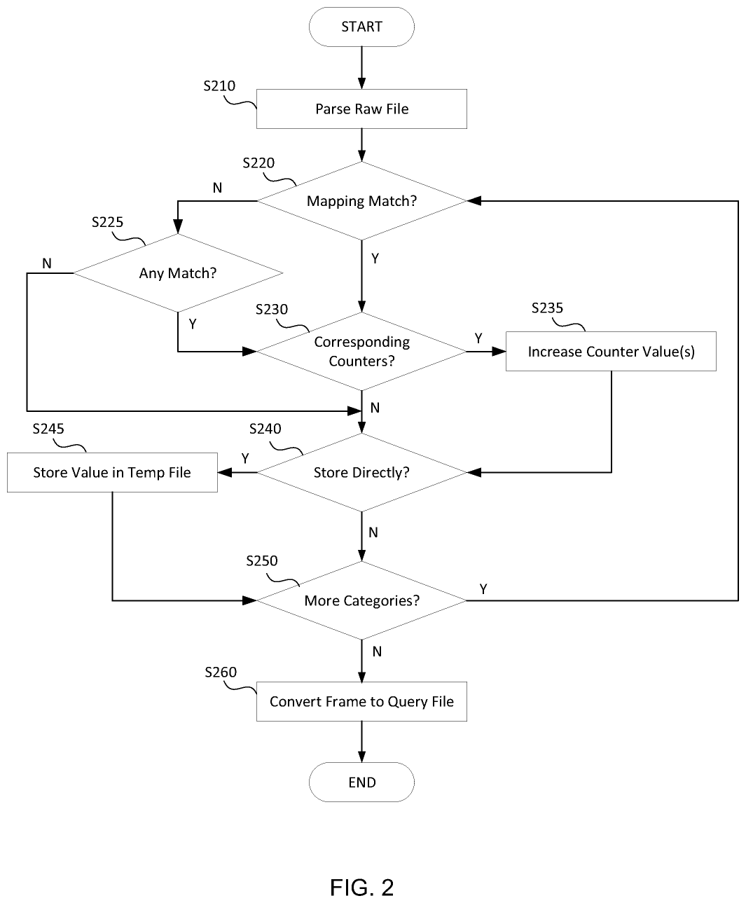

FIG. 2 is a flow diagram illustrating a flow of processes for reformatting of raw data files, in accordance with an exemplary embodiment. This illustrative flow is suitable as the formatting operation S130 of FIG. 1A, although other formatting operations are within the scope of the invention.

At S210, a raw data file is parsed to identify all data category identifiers according to the existing format of the file. As two illustrative examples, a CSV file places its category identifiers in the first row of the file, while an XML file or other parsed structure file uses element names as categories. A suitable algorithm to parse such category identifiers may be prepared for each expected file format.

It is checked at S220 whether a selected one of the uniform category identifiers matches to any category identifiers in the raw file, according to a mapping. If so (“Yes” at S220), the flow continues to S230. If not (“No” at S220), the flow continues to S225.

The matching may be conducted according to a pre-determined category mapping for the source of the raw file, which may map each uniform category identifier of the predetermined set to one of the expected data category identifiers for the source of the raw file. For example, if the source of the raw file is a vendor, definitions of the categories for the raw file may be available from the vendor in an inventory file. This inventory can be used prior to execution of the present flow of processes to create an appropriate category mapping of each relevant category to a corresponding uniform category identifier. Category mappings for a given source may be also be pre-prepared by other means, and may include, if needed, direct administrator review of an exemplary file to determine or intuit which uniform category identifier, if any, corresponds to a given raw file category identifier.

However, the source may be newly encountered or may otherwise lack an existing category mapping. Additionally, the source may have revised the category identifiers of their raw files. Therefore, to the extent the selected uniform category identifier cannot be matched to an identifier in the raw file by a mapping at S220, a comparison may be made at S225 of the uniform category identifier to each raw file category identifier in the raw file to see if a best fit can be identified. Such may be done by a suitable text comparison algorithm of the uniform category identifier to each raw file category identifier. One or more sample data points corresponding to the raw file category identifier may also be checked to determine if they are the expected format: for example, if there is a recognizable number for data corresponding to a suspected “Transmission Frequency” category identifier, and if that number falls within a range used for mobile phone transmissions.

If the comparison S225 is configured to output both a best match and a likelihood of a match, a threshold likelihood may be applied. This threshold may be predetermined in accordance with any suitable system requirements, particularly the acceptability or unacceptability of data being incorrectly categorized, which may vary between uniform categories. A best match which does not meet the threshold likelihood may be discarded, resulting in a “no match” result.

If the comparison S225 produces a “no match” result (“No” at S225), it may be assumed that the selected uniform category identifier is not present in the raw data file. The flow may therefore continue to S240 with the value of the selected uniform category identifier set to a suitable null value.

If the comparison S225 produces a match (“Yes” at S225), the flow continues to S230. Optionally, prior to proceeding to S230, the existing category mapping may be automatically updated, or a new category mapping can be generated, according to this and other determined mapping data.

It is noted that, in implementations where a category mapping is not available, operation S220 may be omitted and the flow of processes may proceed directly from S210 to S225.

If at S230, data corresponding to the selected uniform category identifier can now been identified in the raw file. This data is now reformatted as necessary for placement in at least one of two files, according to the selected uniform category identifier. Namely, the category in question may be desired for use as a direct value, or to be reflected in one or more counter values, or both.

Therefore, at S230, it is determined whether any counter values are predefined to correspond to the selected uniform category identifier and its value in the raw data file. This may be determined in accordance with a table, mapping, or other suitable counter configuration file for defining such a correspondence. Values in this definition may be a single value, a range of values, or a set of enumerated values; or the value may be omitted from consideration such that only the selected uniform category identifier matters.

If there is no correspondence (“No” at S230), the flow continues to S240. If there are corresponding counter values (“Yes” at S230), the flow continues to S235.

An aggregate counter file for the testing cycle is assumed to exist at S235. If it does not exist, it may be generated as part of operation S235, or before the first iteration of operation S235. The generated counter file includes data representing each of a predetermined set of counter values, which may each be initialized to zero. The counter file may also store data identifying the testing cycle, or a corresponding time period. The counter file may be an XML file or other parsed structure file, although the invention is not limited thereto.

At S235, each counter value corresponding to the selected uniform category identifier and its value in the raw data file may be incremented, or otherwise increased in value, in the counter file.

As an example, a raw data file obtained from a particular device may have a category which has been matched to a “Device Technology” uniform category identifier. The value in this category may be a text value, and may in the particular raw file be set to “5G,” which may be understood to indicate that the device operates on “5G” (Fifth Generation standard) technology. A “Number of 5G Devices” counter may be defined to correspond to a “Device Technology” value of “5G”. Therefore, at S235, the “Number of 5G Devices” counter may be incremented by one, to indicate that the system has counted an occurrence of this value in one of the raw data files. It will be clear that, as later raw data files are similarly processed, the “Number of 5G Devices” counter will continue to rise in accordance with the number of raw data files that indicate a “5G” value.

Certain combinations of selected uniform category identifiers and values may instead be counted by adding the value to the corresponding counter. As an example, a raw data file obtained from a particular device may have a value of “100” for a category matched to a “Megabytes Downloaded” uniform category identifier, which may be understood to indicate that 100 megabytes of data were downloaded to the device since the last testing cycle. A “Total Download Throughput” counter may be defined to correspond to any non-zero value in a “Megabytes Downloaded” category. This value of “100” is therefore added to the existing value of the “Total Download Throughput” counter. It will be clear that, as later raw data files are similarly processed, the “Total Download Throughput” counter will continue to rise in accordance with the individual “Megabytes Downloaded” values of individual devices.

Whether a particular counter value should be incremented or have an entire value added may be indicated as part of the counter configuration file.

It is noted that a given combination of uniform category identifier and value may correspond to more than one counter value. It is further noted that, as a result of such a correspondence, the value may be added to one counter value, but trigger an increment of another.

It will be clear that, once every raw data file for a testing cycle has been so processed, the resulting counter values of the counter file will reflect activity over the course of the testing cycle, as represented in the raw data files in the aggregate.

After S235, the flow continues to S240.

At S240, it is determined whether the value for the selected uniform category identifier is to be stored directly. This may be determined in accordance with a table, mapping, or other suitable storage configuration file indicating this, which may be the same file as the counter configuration file or a different file. While this determination need not take the value of the category into account, a determination that uses the value as a factor is within the scope of the disclosure.

As noted previously, if the flow of processes arrived here through the “No at S225” branch, the value in question is not from the raw data file, but is a suitable “null” value.

If the value is not to be stored (“No” at S240), the flow continues to S250. If the value is to be stored (“Yes” at S240), the flow continues to S245.

At S245, the value is placed according to a predefined sequence in a temporary storage file, which may be termed a “data frame,” corresponding to the raw data file. The placement in the sequence may be based on the uniform category identifier, and the sequence may be defined in the storage configuration file.

After S245, the flow continues to S250.

At S250, it is determined whether there are uniform category identifiers in the predetermined set which have not yet been selected. If so (“Yes” at S250), the flow returns to S220 to select another uniform category identifier and perform another iteration of the loop S220 through S250. If not (“No” at S250), the flow continues to S260.

At S260, the data in the data frame is converted to a query file, which may have an ORC format or other suitable format. Each value from the data frame is stored in the query file according to the sequence, and is labeled according to its uniform category identifier, which may be determined according to the sequence. The file as a whole may also store data identifying the testing cycle, or a corresponding time period, and the data source (e.g. device) of the originating raw data file. The file is then output and the process ends.

It is noted that a given value of a raw file may, as a result of this process, be represented both as an individual stored value in the generated query file and in the aggregate of a counter value in the aggregate counter file.

The flow of processes illustrated in FIG. 2 may be repeated for each individual raw data file, using the same aggregate counter file each time. Therefore, each repetition of the flow of processes may end with the generation of another query file, corresponding to the raw data file, and also with appropriate addition of the data in the raw data file to the existing counter values of the aggregate counter file. It is here noted that the resulting query files, as well as the aggregate counter file, may be termed “performance monitoring tool data” such as discussed earlier in the disclosure.

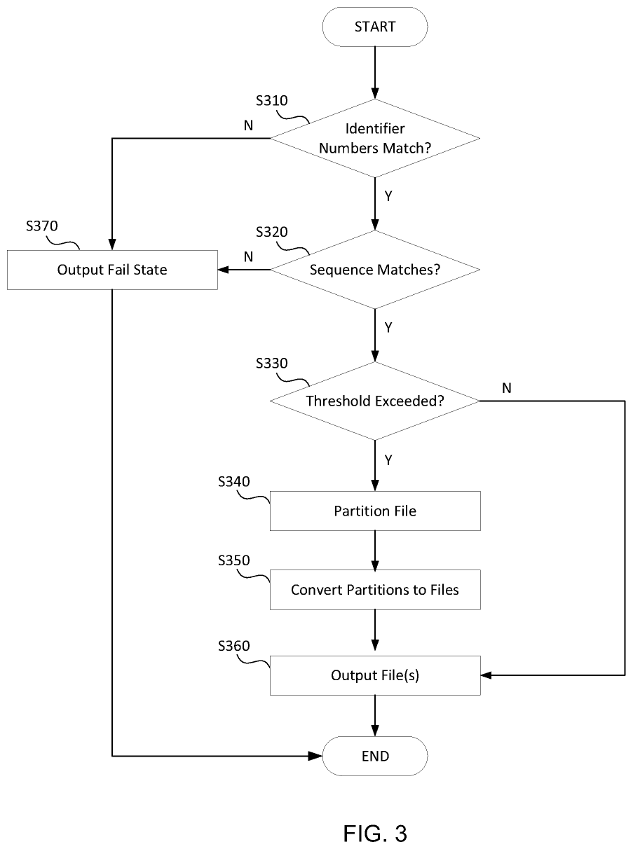

FIG. 3 is a flow diagram illustrating a flow of processes for validating a query data file, in accordance with an exemplary embodiment. This illustrative flow is suitable as the validating operation S140 of FIG. 1A, although other validating operations are within the scope of the invention.

At S310, the number of category identifiers in the data file is checked against a predetermined number of uniform category identifiers. If there is a mismatch (“No” at S310), the flow proceeds to S370, wherein the process outputs a “Failure” state and then exits. If the two numbers match (“Yes” at S310), the flow proceeds to S320.

At S320, each uniform category identifier in the file is compared against the order in the sequence. If an identifier does not correspond to its sequence number, as defined, for example, in the storage configuration file used at S245 (“No” at S310), the flow proceeds to S370, wherein the process outputs a “Failure” state and then exits. If all identifiers correspond to their sequence numbers (“Yes” at S320), the flow proceeds to S330.

The total number of category identifiers may be sizable, to the point of being impractical for storage, analysis, or both. Therefore, at S330, it is checked whether the number of category identifiers exceeds a predefined threshold N. If not (“No” at S330), the flow proceeds to S360. However, if the number of category identifiers exceeds N (“Yes” at S330), then the flow proceeds to S340.

At S340, because the number of category identifiers exceeds N, the file is divided into partitions, each containing N category identifiers or less. In many file formats, including, for example, ORC format, this will be equivalent to dividing the file every N columns of data. Then, at S350, each individual partition is converted to a separate file. The flow then proceeds to S360.

At S360, the process outputs the file or files and a “Valid” state, and then exits. The validated file(s) may now be stored to the query database for later search.

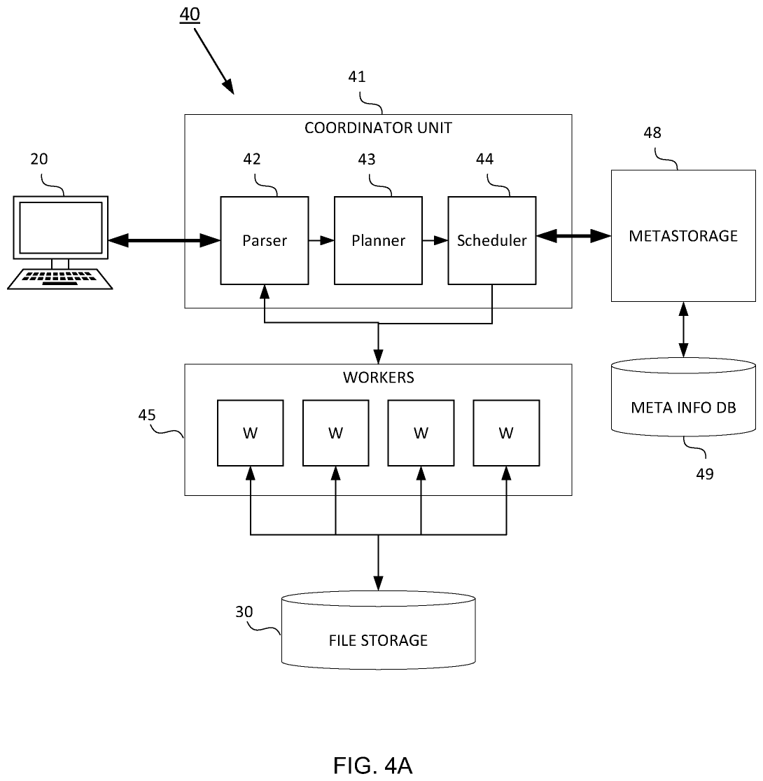

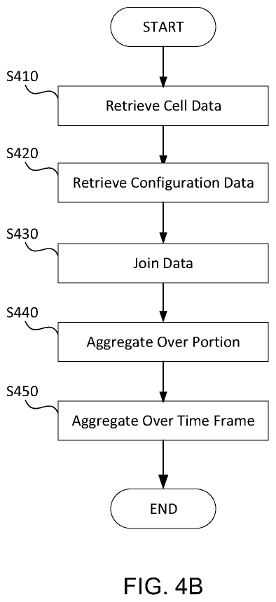

Before discussing the search operation S170 in detail, it may be helpful to discuss the architecture for a subsystem which executes the search operation. FIG. 4A is a block diagram illustrating a system for processing a data search query, in accordance with an exemplary embodiment.

A query system 40 may be organized as a distributed cluster, such as a Trino cluster or similar. A distributed cluster includes a coordinator unit 41 and a set of workers 45, each of which may be a computing device having at least one computer processor and a communication module for connection to the other devices of the cluster. The coordinator unit 41 includes a parser 42, a planner 43, and a scheduler 44, each of which may be software modules executing on a processor of the coordinator unit 41. The query system as a whole is communicatively coupled to a file storage 30, which contains the query database populated at operation S150 of FIG. 1A. A “metastorage” unit 48 stores a directory of the file storage 30 in a meta information database 49.

A user query including a set of parameters is received by the coordinator unit 41 from a user or client 20. The parser 42 parses the query according to its structure to determine its meaning in computer instructions. The planner 43 determines a search strategy to divide the load of the query into subtasks. The scheduler 44 requests address ranges of particular data through the metastorage unit 48, and then schedules and distributes the subtasks among the worker units 45, and the workers 45 each conduct the search on the file storage 30. By operating simultaneously, the workers can each manage a portion of the search, increasing query speed.

Once the workers 45 supply the complete query results to the parser 42, it can return those results to the user.

FIG. 4B is a flow diagram illustrating a flow of processes for processing a data search query, in accordance with an exemplary embodiment. This illustrative flow is suitable as the search operation S160 of FIG. 1B, although other query operations are within the scope of the invention.

At S410, data at the cell level is retrieved from the query database in accordance with the query parameters. This retrieval may be performed, for example, by the query architecture described with reference to FIG. 4A. The query defines, among other factors, a time frame for the data, which may be defined in terms of corresponding testing cycles. Both counter files and query files for the time frame are retrieved. As noted earlier, these files may be termed “performance monitoring tool data.”

At S420, site configuration tool data is retrieved from a database according to the same time frame and other query factors. This database may be the query database, or a separate database associated with the site configuration tools. S420 may occur concurrently with S410.

As described earlier, the site configuration tool data may be recorded less frequently than once per testing cycle. Therefore, although a file of site configuration tool data may be larger than a query file or counter file of performance monitoring tool data, less site configuration tool data files may be used to express the same period of time. As such, one site configuration tool data file may be retrieved at S420 to cover the same time frame as several query files.

At S430, an inner join of the retrieved performance monitoring tool data and the site configuration tool data is performed, removing redundant information and generating an analysis data file for each testing cycle. Several query files and counter files may correspond to a single site configuration tool data file for the reasons described above, and therefore data from the single site configuration tool data file may be joined with each of said query files to generate the analysis data files.

At S440, the analysis data files are aggregated to form the analysis data for the selected portion of the network. For measured values originating, for example, from the query files, one or more of an average, minimum, and maximum value for the selected portion of the network may be determined. For counter values originating, for example, from the counter files, the individual values may be summed to arrive at a total count for the entire selected portion. If only a single cell has been selected, or the selected portion otherwise contains only one relevant data file for each testing cycle, operation S440 may be omitted.

At S450, the data is again aggregated, over the entire selected time period, in the same manner. If only a single testing cycle or the equivalent time period has been selected, operation S450 may be omitted.

At this point, the analysis data is retrieved and in condition for KPI computation, which will now be described in more detail.

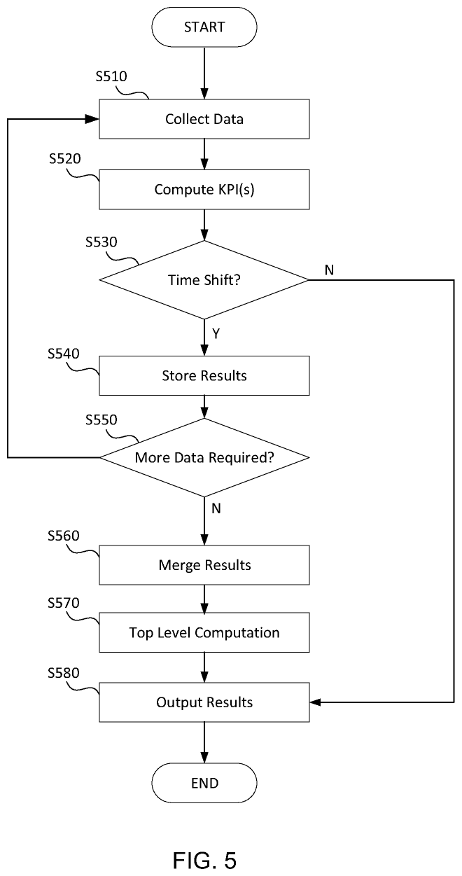

FIG. 5 is a flow diagram illustrating a flow of processes for computing a KPI, in accordance with an exemplary embodiment. This illustrative flow is suitable as the computing operation S170 of FIG. 1B, although other computing operations are within the scope of the invention.

The data retrieved through, for example, the query operation S160 of FIG. 1B, is collected at S510. One or more KPI computations are conducted on this data at S520.

The computation may require a “time shift”; that is, data from a plurality of specific cycles or groups of cycles is needed. This is distinct from a KPI computation for a period which encompasses a plurality of testing cycles, as the individual data for the smaller time periods is being preserved for the computation process. This may be desired, for example, for a comparison of KPI values across cycles. Another reason may be that the given KPI can only be computed on an individual testing cycle, and then summed or otherwise mathematically combined after the fact.

Therefore, at S530, it is checked whether this option has been selected. If not (“No” at S530), the process merely outputs the results at S580 and ends. However, if a timeshift has been selected (“Yes” at S530), the results are stored temporarily at S540. Then, if more such data sets are determined to be required (“Yes” at S550), the process returns to S510 and repeats the collection of data, this time for another data set for a different testing cycle or group of cycles. This flow repeats until all such data sets are analyzed and all results are produced (“No” at S550). Then, the results are merged at S560, a top level computation is performed on the merged results at S570 if needed, and the final results are output at S580.

It will be recognized that the above process may be modified to include, instead of or in addition to a “time shift,” a “portion shift,” where data from a plurality of specified portions of the network are considered.

These and related processes, and other necessary instructions, are preferably encoded as executable instructions on one or more non-transitory computer readable media, such as hard disc drives or optical discs, and executed using one or more computer processors, in concert with an operating system or other suitable measures.

In a software implementation, the software includes a plurality of computer executable instructions, to be implemented on a computer system. Prior to loading in a computer system, the software preferably resides as encoded information on a suitable non-transitory computer-readable tangible medium, such as magnetically, optically, or other suitably encoded or recorded media. Specific media can include but are not limited to magnetic floppy disks, magnetic tapes, CD-ROMs, DVD-ROMs, solid-state disks, or flash memory devices, and in certain embodiments take the form of pre-existing data storage (such as “cloud storage”) accessible through an operably coupled network means (such as the Internet).

In certain implementations, a system includes a dedicated processor or processing portions of a system on chip (SOC), portions of a field programmable gate array (FPGA), or other such suitable measures, executing processor instructions for performing the functions described herein or emulating certain structures defined herein. Suitable circuits using, for example, discrete logic gates such as in an Application Specific Integrated Circuit (ASIC), Programmable Logic Array (PLA), or Field Programmable Gate Arrays (FPGA) are in certain embodiments also developed to perform these functions.

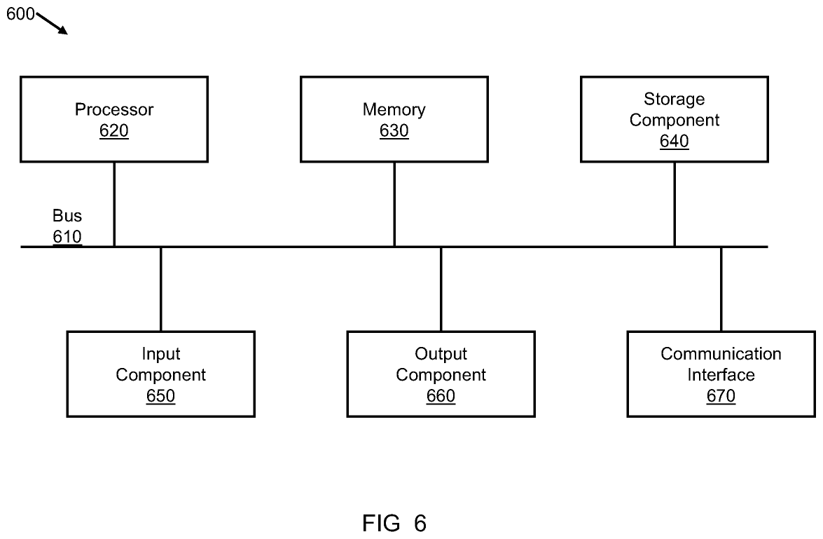

FIG. 6 is a diagram of example components of a device 600. Device 600 may correspond to the coordinator unit 41 and/or any of the workers 45. As shown in FIG. 6, device 600 may include a bus 610, a processor 620, a memory 630, a storage component 640, an input component 650, an output component 660, and a communication interface 670.

Bus 610 includes a component that permits communication among the components of device 600. Processor 620 may be implemented in hardware, firmware, or a combination of hardware and software. Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 includes one or more processors capable of being programmed to perform a function. Memory 630 includes a random access memory (RAM), a read only memory (ROM), and/or another type of dynamic or static storage device (e.g., a flash memory, a magnetic memory, and/or an optical memory) that stores information and/or instructions for use by processor 620.

Storage component 640 stores information and/or software related to the operation and use of device 600. For example, storage component 640 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 650 includes a component that permits device 600 to receive information, such as via user input (e.g., a touch screen display, a keyboard, a keypad, a mouse, a button, a switch, and/or a microphone). Additionally, or alternatively, input component 650 may include a sensor for sensing information (e.g., a global positioning system (GPS) component, an accelerometer, a gyroscope, and/or an actuator). Output component 660 includes a component that provides output information from device 600 (e.g., a display, a speaker, and/or one or more light-emitting diodes (LEDs)).

Communication interface 670 includes a transceiver-like component (e.g., a transceiver and/or a separate receiver and transmitter) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

Device 600 may perform one or more processes described herein. Device 600 may perform these processes in response to processor 620 executing software instructions stored by a non-transitory computer-readable medium, such as memory 630 and/or storage component 640. A computer-readable medium is defined herein as a non-transitory memory device. A memory device includes memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

In embodiments, any one of the operations or processes of FIGS. 1, 2, 3, 4B, and 5 may be implemented by or using any one of the elements illustrated in FIG. 6.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for long-term storage of network performance data for later retrieval, the method comprising, by at least one processor, for at least one testing cycle for a network:
obtaining a plurality of performance data files corresponding to the testing cycle, each of the plurality of performance data files comprising data describing network performance, the plurality of performance data files comprising at least a first data file of a first format and a second data file of a second format different from the first format;
reformatting each of the plurality of performance data files according to a predetermined uniform file format and a predefined set of uniform category identifiers, to obtain a plurality of uniform data files; and
storing the plurality of uniform data files to a query database in a memory.

2. The method of claim 1,
wherein each performance data file is reformatted by:
parsing the performance data file according to a format of the performance data file to identify a plurality of data category identifiers in the performance data file, each of the plurality of data category identifiers having a corresponding data value in the performance data file,
matching each of the predefined set of uniform category identifiers to a respective one of the plurality of data category identifiers of the performance data file,
increasing a counter value of at least one counter in an aggregate counter file based on a uniform category identifier having a predefined correspondence to the counter, and on a data value of a data category identifier matched to the uniform category identifier having a predefined correspondence to the counter,
storing a data value of at least one data category identifier to a sequence location in a temporary data frame based on the sequence location having a predefined correspondence to a uniform category identifier matched to the data category identifier, and
converting the temporary data frame to a uniform data file having the predetermined uniform file format; and
wherein the storing of the plurality of uniform data files to the query database includes storing the aggregate counter file.

3. The method of claim 2, wherein the matching is based on a pre-determined category mapping corresponding to a source of the performance data file.

4. The method of claim 2, wherein the matching is based on:
a text comparison of the uniform category identifier with the data category identifier, and
a comparison of an expected format and expected range corresponding to the uniform category identifier with a sample data point corresponding to the data category identifier in the performance data file.

5. The method of claim 1, further comprising validating each of the plurality of uniform data files, each of the plurality of uniform data files being partitioned during validation according to a predefined category identifier threshold.

6. The method of claim 1, further comprising storing at least one configuration data file for each of a plurality of network cells, wherein a frequency of storage of configuration data files is less than a frequency of testing cycles.

7. A method for analysis of past network performance, the method comprising, by at least one processor:
storing a plurality of uniform data files to a query database in a memory by the method of claim 1;
searching the query database according to a received search request to thereby obtain a retrieved set of uniform data files; and
computing at least one performance indicator based on the retrieved set of uniform data files.

8. The method of claim 7, wherein:
the received search request defines a selected time frame,
each of the retrieved set of uniform data files corresponds to a testing cycle within the selected time frame,
values in the retrieved set of uniform data files are aggregated to determine representative values for the selected time frame, and
the at least one performance indicator is computed based on the representative values for the selected time frame.

9. The method of claim 7, wherein:
the received search request defines a selected network portion,
each of the retrieved set of uniform data files corresponds to a cell within the selected network portion,
values in the retrieved set of uniform data files are aggregated to determine representative values for the selected network portion, and
the at least one performance indicator is computed based on the representative values for the selected network portion.

10. A method for analysis of past network performance, the method comprising, by at least one processor:
storing a plurality of uniform data files to a query database in a memory by the method of claim 6;
searching the query database according to a received search request to thereby obtain a retrieved set of uniform data files and a retrieved set of configuration data files, the received search request defining a selected time frame, each of the retrieved set of uniform data files and each of the retrieved set of configuration data files corresponding to the selected time frame;
merging data from the retrieved set of uniform data files with data from the retrieved set of configuration data files to generate a set of analysis data files; and
computing at least one performance indicator based on the set of analysis data files.

11. A system for long-term storage of network performance data for later retrieval, the system comprising:
at least one non-volatile memory electrically configured to store computer program code; and
at least one processor operatively connected to the at least one non-volatile memory, the at least one processor being configured to operate as instructed by the computer program code, the computer program code including:
file retrieval code configured to cause at least one of the at least one processor to obtain a plurality of performance data files corresponding to a testing cycle, each of the plurality of performance data files comprising data describing network performance, the plurality of performance data files comprising at least a first data file of a first format and a second data file of a second format different from the first format,
formatting code configured to cause at least one of the at least one processor to reformat each of the plurality of performance data files according to a predetermined uniform file format and a predefined set of uniform category identifiers, to obtain a plurality of uniform data files, and
storage code configured to cause at least one of the at least one processor to store the plurality of uniform data files to a query database in a query memory.

12. The system of claim 11,
wherein each performance data file is reformatted by:
parsing the performance data file according to a format of the performance data file to identify a plurality of data category identifiers in the performance data file, each of the plurality of data category identifiers having a corresponding data value in the performance data file,
matching each of the predefined set of uniform category identifiers to a respective one of the plurality of data category identifiers of the performance data file,
increasing a counter value of at least one counter in an aggregate counter file based on a uniform category identifier having a predefined correspondence to the counter, and on a data value of a data category identifier matched to the uniform category identifier having a predefined correspondence to the counter,
storing a data value of at least one data category identifier to a sequence location in a temporary data frame based on the sequence location having a predefined correspondence to a uniform category identifier matched to the data category identifier, and
converting the temporary data frame to a uniform data file having the predetermined uniform file format; and
wherein the storage code is further configured to cause at least one of the at least one processor to store the aggregate counter file.

13. The system of claim 12, wherein the matching is based on a predetermined category mapping corresponding to a source of the performance data file.

14. The system of claim 12, wherein the matching is based on:
a text comparison of the uniform category identifier with the data category identifier, and
a comparison of an expected format and expected range corresponding to the uniform category identifier with a sample data point corresponding to the data category identifier in the performance data file.

15. The system of claim 11, wherein the computer program code further comprises validating code configured to cause at least one of the at least one processor to validate each of the plurality of uniform data files, each of the plurality of uniform data files being partitioned during validation according to a predefined category identifier threshold.

16. The system of claim 11, wherein the storage code is further configured to cause at least one of the at least one processor to store at least one configuration data file for each of a plurality of network cells, a frequency of storage of configuration data files being less than a frequency of testing cycles.

17. A non-transitory computer-readable recording medium having recorded thereon instructions executable by at least one processor to perform a method for long-term storage of network performance data for later retrieval, the method comprising, for at least one testing cycle for a network:
obtaining a plurality of performance data files corresponding to the testing cycle, each of the plurality of performance data files comprising data describing network performance, the plurality of performance data files comprising at least a first data file of a first format and a second data file of a second format different from the first format;
reformatting each of the plurality of performance data files according to a predetermined uniform file format and a predefined set of uniform category identifiers, to obtain a plurality of uniform data files; and
storing the plurality of uniform data files to a query database in a memory.

18. The recording medium of claim 17,
wherein each performance data file is reformatted by:
parsing the performance data file according to a format of the performance data file to identify a plurality of data category identifiers in the performance data file, each of the plurality of data category identifiers having a corresponding data value in the performance data file,
matching each of the predefined set of uniform category identifiers to a respective one of the plurality of data category identifiers of the performance data file,
increasing a counter value of at least one counter in an aggregate counter file based on a uniform category identifier having a predefined correspondence to the counter, and on a data value of a data category identifier matched to the uniform category identifier having a predefined correspondence to the counter,
storing a data value of at least one data category identifier to a sequence location in a temporary data frame based on the sequence location having a predefined correspondence to a uniform category identifier matched to the data category identifier, and
converting the temporary data frame to a uniform data file having the predetermined uniform file format; and
wherein the storing of the plurality of uniform data files to the query database includes storing the aggregate counter file.

19. The recording medium of claim 17, wherein the method further comprises validating each of the plurality of uniform data files, each of the plurality of uniform data files being partitioned during validation according to a predefined category identifier threshold.

20. The recording medium of claim 17, wherein the method further comprises storing at least one configuration data file for each of a plurality of network cells, wherein a frequency of storage of configuration data files is less than a frequency of testing cycles.
